(19) United States
(12) Patent Application Publication
(10) Pub. No.: US 2023/0325917 A1
(43) Pub. Date: Oct. 12, 2023

(54) SYSTEMS AND METHODS FOR PROVIDING ALTERNATE DEAL STRUCTURES

(71) Applicant: JPMORGAN CHASE BANK, N.A., New York, NY (US)

(72) Inventors: Ajith RAMAN, Glen Mills, PA (US); Narayana Swamy THOTA, Newark, DE (US); Rama YADDANAPUDI, Sellersville, PA (US); Puneet KUMAR, Tampa, FL (US); Robert SEAMAN, Huntington, NY (US)

(21) Appl. No.: 18/192,985

(22) Filed: Mar. 30, 2023

(30) Foreign Application Priority Data
Mar. 31, 2022 (IN) 202211019446

(51) Int. Cl. G06Q 40/03

(52) U.S. Cl. CPC G06Q 40/03

(57) ABSTRACT

Systems and methods for providing alternate deal structures are disclosed. A method may include: receiving an application for a loan having a loan structure comprising loan parameters from a dealer or an individual; retrieving data for the individual from a third party data source; decisioning the initial loan structure using the parameters and the cached data; returning an approval for the initial loan structure and an interest rate for the initial loan structure to the dealer or the individual; generating additional loan structures, each having a plurality of different parameters; decisioning the additional loan structures using the different parameters and the cached data; ranking the additional loan structures with the interest rate for each additional loan structure; returning approval and the interest rate for the ranked loan structures to the dealer or the individual; and receiving acceptance of the initial loan structure or one of the additional loan structures.

### RELATED APPLICATIONS

This application claims priority to, and the benefit of, Indian Patent Application No. 202211019446, filed Mar. 31, 2022, the disclosure of which is hereby incorporated, by reference, in its entirety.

### BACKGROUND OF THE INVENTION

### 1. Field of the Invention

Embodiments generally relate to systems and methods for providing alternative deal structures.

### 2. Description of the Related Art

When an individual decides to purchase a vehicle from a dealer using financing, the dealer typically submits an application including the individual’s information to multiple lenders and receives multiple responses from those lenders. If the dealer decides to change a loan parameter, such as the term or the amount financed, the dealer must re-submit the application with the changed parameters to the lenders for approval. Thus, multiple reviews of the application are required, and the individual may still not be aware of the best financing option available.

### SUMMARY OF THE INVENTION

Systems and methods for providing alternative deal structures are disclosed. In one embodiment, a method for providing alternate deal structures may include: (1) receiving, by a lender computer program executed by a computer processor, an application for a loan having an initial loan structure comprising a plurality of loan parameters from a dealer or an individual; (2) generating, by the lender computer program, data for the individual from a third party data source; (3) caching, by the lender computer program, the data in a local cache; (4) decisioning, by the lender computer program, the initial loan structure using the plurality of parameters and the cached data; (5) returning, by the lender computer program, an approval for the initial loan structure and an interest rate for the initial loan structure to the dealer or the individual; (6) generating, by the lender computer program, a plurality of additional loan structures, each additional loan structure having a plurality of different parameters; (7) decisioning, by the lender computer program, each of the plurality of additional loan structures using the different parameters for each additional loan structure and the cached data; (8) ranking, by the lender computer program, the additional loan structures with the interest rate for each additional loan structure; (9) returning, by the lender computer program, approval for each of the ranked loan structures and the interest rate for each of the additional loan structures to the dealer or the individual; and (10) receiving, by the lender computer program, acceptance of the initial loan structure or one of the additional loan structures.

In one embodiment, the plurality of loan parameters may include a loan term, a loan amount, and a down payment amount.

In one embodiment, the third party data source may include a credit bureau.

In one embodiment, the different loan parameters in each of the additional loan structures may differ by at least one of the loan term, the loan amount, and the down payment amount.

In one embodiment, the additional loan structures may be ranked based on predicted acceptance rates for each of the plurality of addition loan structure.

In one embodiment, the predicted acceptance rates may be generated by a machine learning engine that is trained using acceptances from individual having a similar income, credit score, geographical area, and/or vehicle being purchased.

In one embodiment, approval for the initial loan structure and the approval for the additional loan structures may include embedded annotations. The annotations may identify a unique feature of the initial loan structure or the additional loan structure.

According to another embodiment, a system may include a lender server executing a lender computer program and comprising a local cache, a loan structure database comprising a plurality of loan structures, a third party data source, an individual electronic device for an individual executing an individual computer program, and a dealer electronic device executing a dealer computer program. The lender computer program receives an application for a loan having an initial loan structure comprising a plurality of loan parameters from the dealer computer program or an individual computer program, receives data for the individual from the third party data source, caches the data in the local cache, decisions the initial loan structure using the plurality of parameters and the cached data, returns an approval for the initial loan structure and an interest rate for the initial loan structure to the dealer computer program or the individual computer program, generates a plurality of additional loan structures from the plurality of loan structures in the loan structure database, each additional loan structure having a plurality of different parameters, decisions each of the plurality of additional loan structures using the different parameters for each additional loan structure and the cached data, ranks the additional loan structures with the interest rate for each additional loan structure, returns approval for each of the ranked loan structures and the interest rate for each of the additional loan structures to the dealer computer program or the individual computer program, and receives acceptance of the initial loan structure or one of the additional loan structures from the dealer computer program or the individual computer program.

In one embodiment, the plurality of loan parameters may include a loan term, a loan amount, and a down payment amount.

In one embodiment, the third party data source may include a credit bureau.

In one embodiment, the different loan parameters in each of the additional loan structures may differ by at least one of the loan term, the loan amount, and the down payment amount.

In one embodiment, the additional loan structures may be ranked based on predicted acceptance rates for each of the plurality of addition loan structure.

In one embodiment, the predicted acceptance rates may be generated by a machine learning engine that is trained using acceptances from individual having a similar income, credit score, geographical area, and/or vehicle being purchased.

In one embodiment, approval for the initial loan structure and the approval for the additional loan structures may include embedded annotations. The annotations may identify a unique feature of the initial loan structure or the additional loan structure.

According to another embodiment, a non-transitory computer readable storage medium, may include instructions stored thereon, which when read and executed by one or more computer processors, cause the one or more computer processors to perform steps comprising: receiving an application for a loan having an initial loan structure comprising a plurality of loan parameters from a dealer or an individual; retrieving data for the individual from a credit bureau; caching the data in a local cache; decisioning the initial loan structure using the plurality of parameters and the cached data; returning an approval for the initial loan structure and an interest rate for the initial loan structure to the dealer or the individual; generating a plurality of additional loan structures, each additional loan structure having a plurality of different parameters, wherein the different loan parameters in each of the additional loan structures differ by at least one of a loan term, a loan amount, and a down payment amount; decisioning each of the plurality of additional loan structures using the different parameters for each additional loan structure and the cached data; ranking the additional loan structures with the interest rate for each additional loan structure, wherein the additional loan structures are ranked based on predicted acceptance rates for each of the plurality of addition loan structure; returning approval for each of the ranked loan structures and the interest rate for each of the additional loan structures to the dealer or the individual; and receiving acceptance of the initial loan structure or one of the additional loan structures.

In one embodiment, the plurality of loan parameters may include a loan term, a loan amount, and a down payment amount.

In one embodiment, the predicted acceptance rates may be generated by a machine learning engine that is trained using acceptances from individual having a similar income, credit score, geographical area, and/or vehicle being purchased.

In one embodiment, approval for the initial loan structure and the approval for the additional loan structures may include embedded annotations, and the annotations may identify a unique feature of the initial loan structure or the additional loan structure.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for providing alternative deal structures according to an embodiment;

FIG. 2 depicts a method providing alternative deal structures according to an embodiment;

FIG. 3 depicts an exemplary screenshot of a user interface providing additional offer according to an embodiment;

FIG. 4 depicts an exemplary screenshot of a user interface providing dealer options for an additional offer according to an embodiment;

FIG. 5 depicts an exemplary screenshot of a user interface providing an acceptance screen according to an embodiment; and

FIG. 6 depicts an exemplary computing system for implementing aspects of the present disclosure.

### DETAILED DESCRIPTION OF PREFERRED EMBODIMENTS

Embodiments generally relate to systems and methods for providing alternative deal structures.

Embodiments may return a plurality of financing offers, including a response for the requested loan parameters, to a dealer along with an initial decision response so that dealers can present additional loan structures to the individual without having to contact the lender each time with a different loan structure. This avoids repeated requests for underwriting approval. Thus, the dealer can present any of the already approved loan structures to the individual.

In another embodiment, an individual may submit parameters directly to the lender using a computer program or application, and may receive a plurality of approved loan structures. The individual may then present approved financing to the dealer to complete the purchase.

In one embodiment, the loan structures may be ranked and presented to the dealer and/or individual directly. In one embodiment, the ranking may be based on rules, based on predicted acceptance rates using a trained machine learning engine (e.g., for similarly situated individuals in the same geographical area, with similar credit scores, income, loan parameters, combinations thereof, etc.), etc. The result of the loan offer may be fed-back to retrain the machine learning engine and update the weights for the algorithm.

In one embodiment, the initial loan structure with the loan parameters received with the loan application may be decisioned, and then any additional loan structures may be decisioned. The data that is used to decision the initial decision (e.g., credit score, income, etc.) may be cached and may be re-used for the additional decisioning. The additional decisioning for the additional loan structures may be performed in parallel.

In one embodiment, the additional loan structures may also include lease structures.

In one embodiment, the additional decisioning may be performed only if the application with the initial parameters is approved. In another embodiment, if the application is rejected, the parameters may be adjusted based on the reason for the rejection, and additional loan structures with alternate parameters may be decisioned.

In another embodiment, the data may be retrieved and cached, and then all loan structures, including the one included in the application, may be decisioned in parallel.

Embodiments may use asynchronous communications with the dealer platform. For example, in order to minimize delays in reporting the initial decision, the embodiments may use an event-driven approach for triggering the creation and decisioning of the alternate deal structures while the initial decision response is returned to the dealer. Once the alternate deal structures are completed, the decisions may be pushed to the dealer using a different Application Programming Interface (API) endpoint. This allows for the initial decision response to the dealer to be provided quickly, while providing the alternate structures asynchronously.

Embodiments may use database-based caching for information received for decisioning. For example, during the initial decision, the business object model used for the decision may be cached into a distributed instance of a database and then used during the decisioning of the alternate structures. This reduces the amount of time spent on decisioning the additional data structures.

Data serialization and caching of several data elements may be used to speed up overall performance of alternate deal structure decisions.

The number of deal structures that are offered to the dealer based on the performance of the system may be optimized. For example, the offers may be decisioned based on an anticipated acceptance for the loan structures based on a rules engine, a trained machine engine, etc.

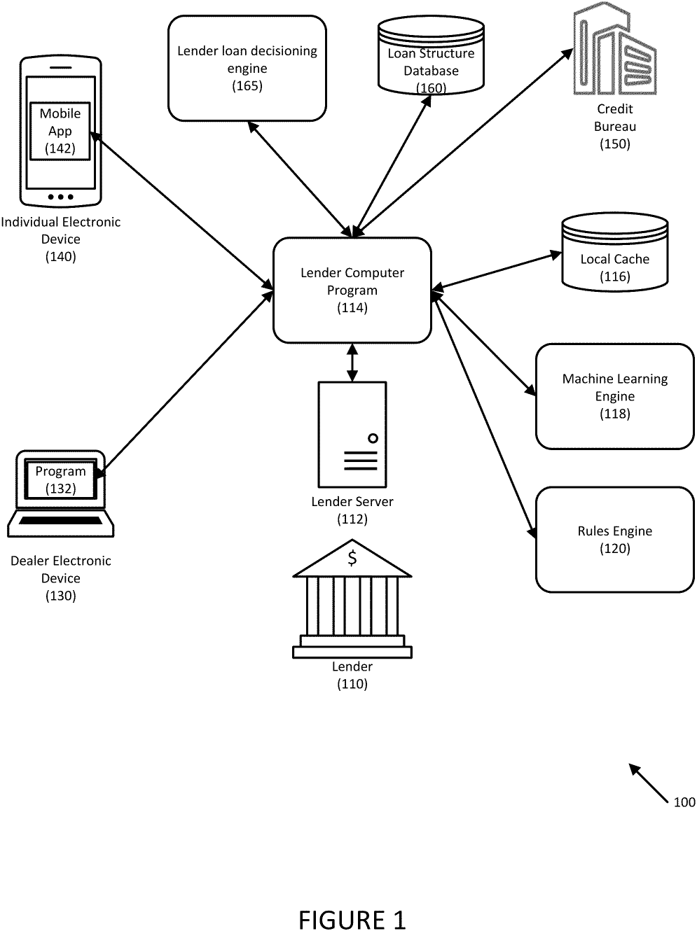

Referring to FIG. 1, a system for providing alternate deal structures is illustrated according to an embodiment. System 100 may include lender 110 that may provide lender server 112. Lender server 112 may be any suitable computing device, including physical and/or cloud-based servers. Lender 110 may be a financial institution, such as a bank.

Lender server 112 may execute lender computer program 114 that may interface with loan structure database 160, which may store a plurality of alternate loan structures for loans. Lender computer program 114 may also interface with lender loan decisioning engine 165, which may decision the loan structures. Lender computer program 114 may also interface with one or more sources of third party data, such as credit bureau 150. Lender computer program 114 may store data received from third parties (e.g., credit bureau 150, etc.), and data received in the loan application in local cache 116.

Lender computer program 114 may use machine learning engine 118 and/or rules engine 120 to predict an acceptance rate of the loan structures in order to rank the loan structures. Lender computer program 114 may further present an annotation for each loan structure that may identify a unique feature for the loan structure (e.g., “$0 down,” “Most popular”), etc. The annotations may be embedded in the approvals and may be presented with the rankings, may be presented with the user hovers over the loan structure, etc.

Lender computer program 114 may receive the loan application from computer program 132 executed by dealer electronic device 130 or from mobile application or program 142 that may be executed by individual electronic device 140.

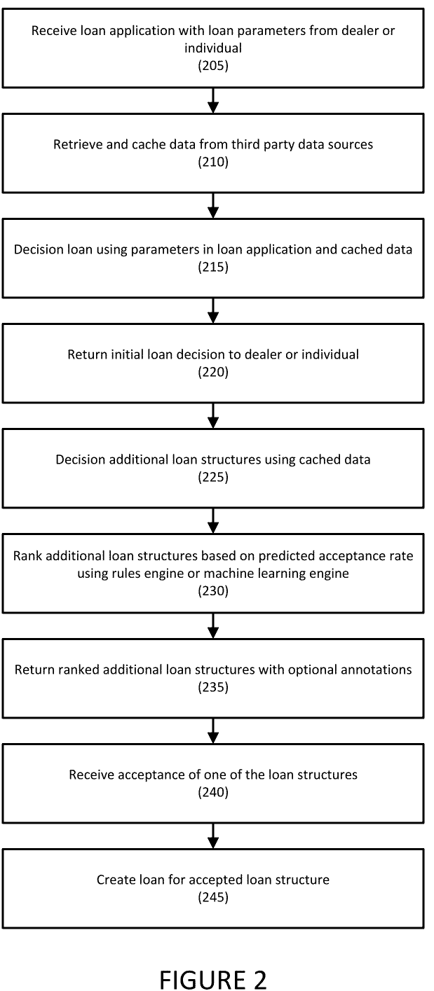

Referring to FIG. 2, a method for providing alternate deal structures is illustrated according to an embodiment.

In step 205, a lender computer program may receive a loan application with loan parameters from a dealer or an individual. The loan application may be for an initial loan structure (e.g., an initial term, an initial amount, an initial down payment, etc.)

In step 210, the lender computer program may retrieve and cache data from third party data sources (e.g., a credit bureau) and/or other data sources. The lender computer program may cache the data in a local cache.

In step 215, the lender computer program may decision the loan structure using on the parameters in the application and on the cached data. In one embodiment, the decisioning may be performed by a loan decisioning engine for the lender.

In step 220, the lender computer program may return an initial loan decision to the dealer or the individual for the initial loan structure. In one embodiment, the initial loan decision may be provided to a first API endpoint exposed by the dealer.

In one embodiment, the initial loan decision may include an interest rate for the received parameters.

In step 225, the lender computer program may generate additional loan structures, each having different parameters from the parameters in the initial loan structure (e.g., different loan terms, different loan amounts, different down payments, etc.), and may decision each of the additional loan structures. In one embodiment, the decisioning may be performed by a loan decisioning engine for the lender.

In one embodiment, the additional loan structures may also include lease structures.

In one embodiment, the additional decisioning may only be performed if the individual is approved for the initial loan structure using the initial parameters.

In one embodiment, the decisioning on the additional loan structures may be performed in parallel, or substantially in parallel.

In step 230, the lender computer program may rank the additional loan structures before they are provided to the lender or individual. In one embodiment, the lender computer program may use a rules engine or a trained machine learning engine to rank the additional loan structures. The additional loan structures may be ranked using rules, may be based on predicted acceptance rates using a trained machine learning engine (e.g., for similarly situated individuals in the same geographical area, with similar credit scores, income, loan parameters, combinations thereof, etc.), etc.

In one embodiment, if the loan parameters received in the application were rejected, the lender computer program may modify the parameters to identify one or more loan structures that are approved.

In step 235, the lender computer program may return the ranked loan structures to the dealer or individual. In one embodiment, only the approved loan structures may be returned. In one embodiment, the ranked loan structures may be presented with annotations that may be visible at all times, or may be visible only when the loan structure is “hovered” over.

In one embodiment, the lender computer program may return the ranked loan structures to the dealer asynchronously using, for example, a second API endpoint that may be different from the first API endpoint.

In one embodiment, only a subset of the additional loan structures may be returned. For example, the top five additional loan structures may be presented with the requested loan structures. The number of additional loan structures may vary as is necessary and/or desired.

In one embodiment, the number and type of additional loan structures that are presented may be selected based on a predicted customer goal. For example, prior experience with the specific customer on prior deals, or with similarly situated customers (e.g., having similar income levels, purchasing the same vehicle, etc.) may be considered to predict the customer’s goal and thereby present the most attractive alternate loan structures for the customer goal. For example, if the predicted customer goal is reduce monthly payments, then longer term loan structures may be presented. As another example, if the predicted customer goal is to have lower interest rates, then shorter term loan structures may be presented. The machine learning engine may be retrained as is necessary and/or desired.

In one embodiment, the lender computer program may also return the dealer compensation for each loan structure, such as the amount of financial that the dealer will receive over the course of the loan.

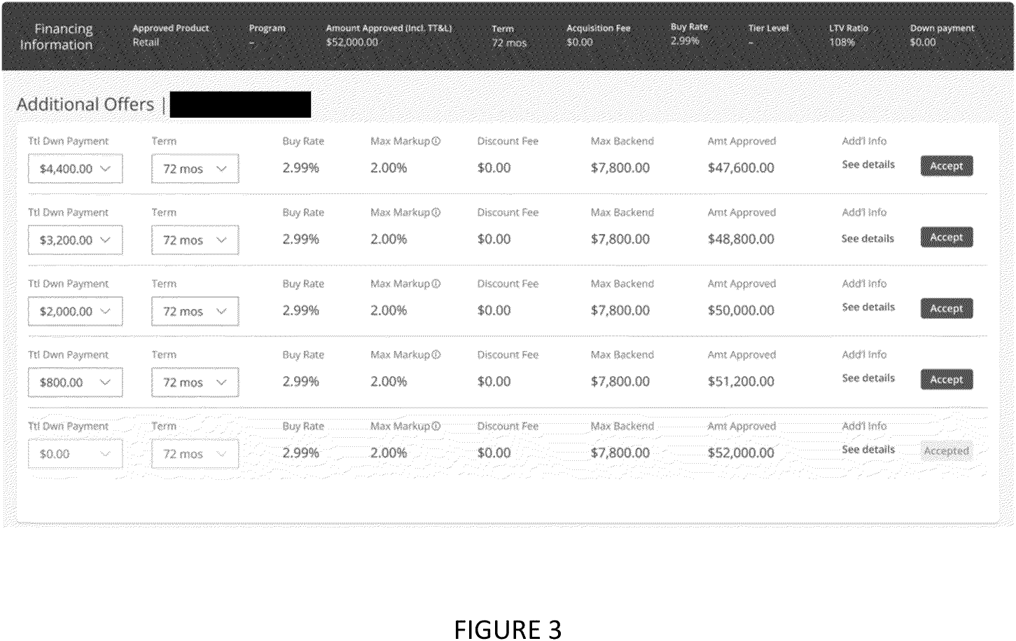

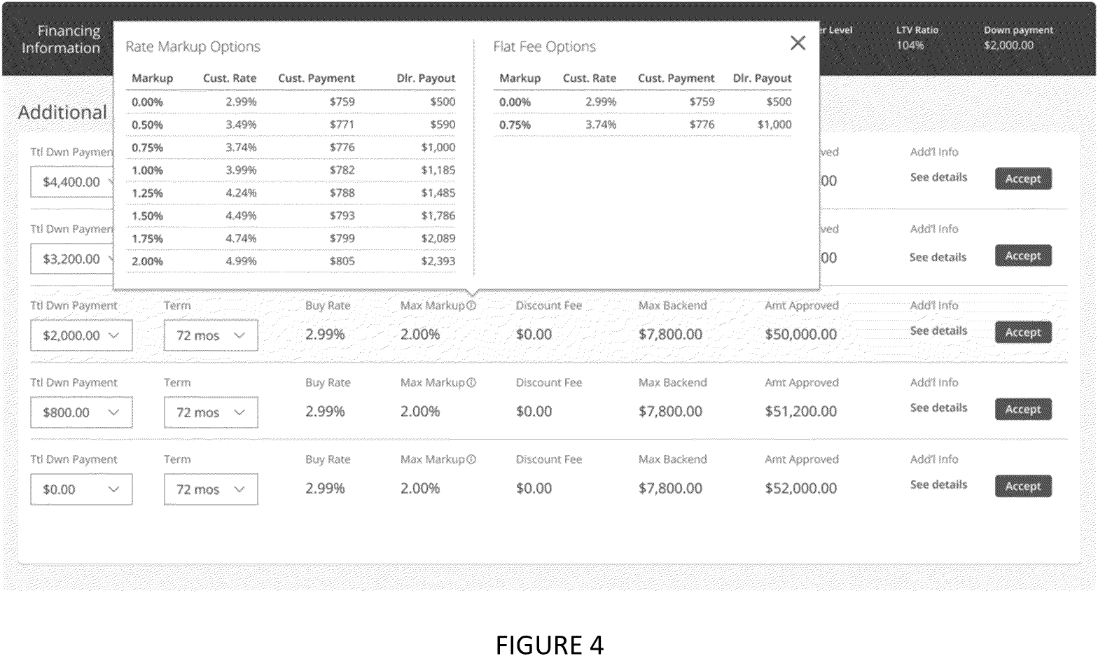

An example user interface depicting the loan options is provided in FIG. 3. An example user interface providing additional details on one of the loan options is provided in FIG. 4.

In step 240, the lender computer program may receive acceptance of one of the loan structures, and in step 245, the lender computer program may create a loan for the accepted loan structure.

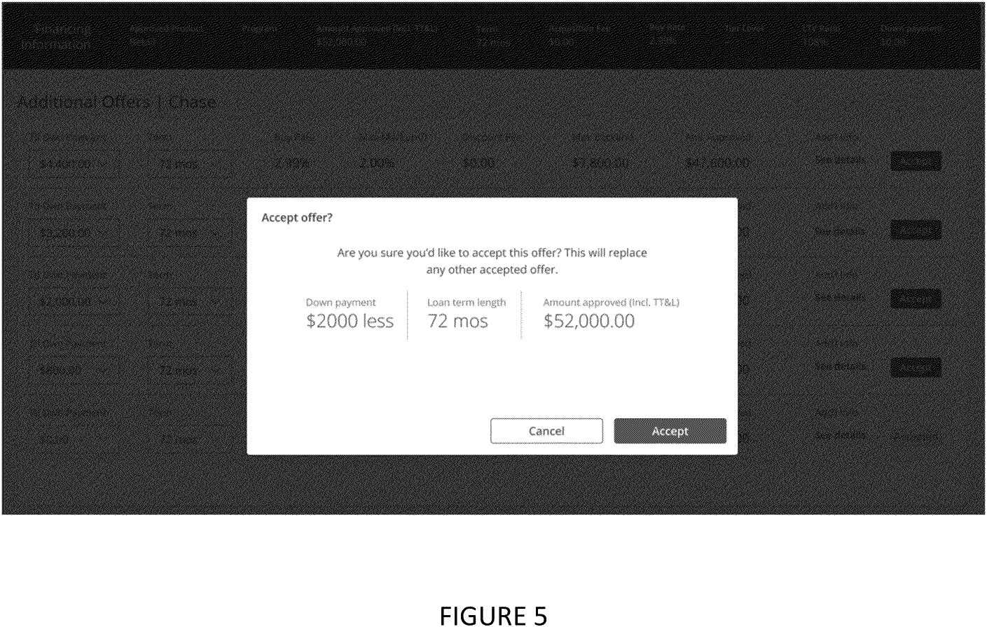

FIG. 5 depicts an example user interface for accepting a loan offer.

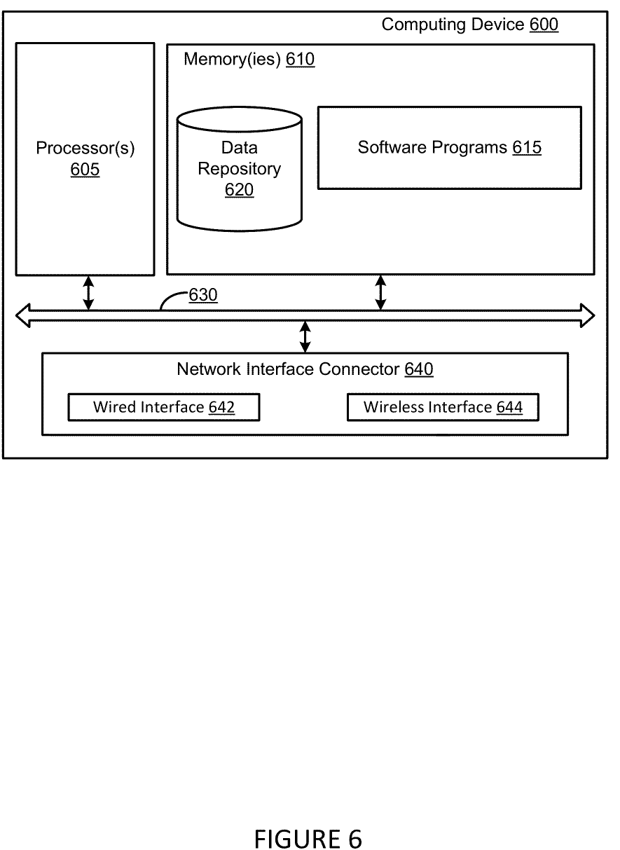

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing alternate deal structures, comprising:
receiving, by a lender computer program executed by a computer processor, an application for a loan having an initial loan structure comprising a plurality of loan parameters from a dealer or an individual;
retrieving, by the lender computer program, data for the individual from a third party data source;
caching, by the lender computer program, the data in a local cache;
decisioning, by the lender computer program, the initial loan structure using the plurality of parameters and the cached data;
returning, by the lender computer program, an approval for the initial loan structure and an interest rate for the initial loan structure to the dealer or the individual;
generating, by the lender computer program, a plurality of additional loan structures, each additional loan structure having a plurality of different parameters;
decisioning, by the lender computer program, each of the plurality of additional loan structures using the different parameters for each additional loan structure and the cached data;
ranking, by the lender computer program, the additional loan structures with the interest rate for each additional loan structure;
returning, by the lender computer program, approval for each of the ranked loan structures and the interest rate for each of the additional loan structures to the dealer or the individual; and
receiving, by the lender computer program, acceptance of the initial loan structure or one of the additional loan structures.

2. The method of claim 1, wherein the plurality of loan parameters comprise a loan term, a loan amount, and a down payment amount.

3. The method of claim 1, wherein the third party data source comprises a credit bureau.

4. The method of claim 2, wherein the different loan parameters in each of the additional loan structures differ by at least one of the loan term, the loan amount, and the down payment amount.

5. The method of claim 1, wherein the additional loan structures are ranked based on predicted acceptance rates for each of the plurality of addition loan structure.

6. The method of claim 5, wherein the predicted acceptance rates are generated by a machine learning engine that is trained using acceptances from individual having a similar income, credit score, geographical area, and/or vehicle being purchased.

7. The method of claim 1, wherein approval for the initial loan structure and the approval for the additional loan structures comprise embedded annotations.

8. The method of claim 7, wherein the annotations identify a unique feature of the initial loan structure or the additional loan structure.

9. A system, comprising:
a lender server executing a lender computer program and comprising a local cache;
a loan structure database comprising a plurality of loan structures;
a third party data source;
an individual electronic device for an individual executing an individual computer program; and
a dealer electronic device executing a dealer computer program; wherein:
the lender computer program receives an application for a loan having an initial loan structure comprising a plurality of loan parameters from the dealer computer program or an individual computer program;
the lender computer program receives data for the individual from the third party data source;
the lender computer program caches the data in the local cache;
the lender computer program decisions the initial loan structure using the plurality of parameters and the cached data;
the lender computer program returns an approval for the initial loan structure and an interest rate for the initial loan structure to the dealer computer program or the individual computer program;
the lender computer program generates a plurality of additional loan structures from the plurality of loan structures in the loan structure database, each additional loan structure having a plurality of different parameters;
the lender computer program decisions each of the plurality of additional loan structures using the different parameters for each additional loan structure and the cached data;
the lender computer program ranks the additional loan structures with the interest rate for each additional loan structure;
the lender computer program returns approval for each of the ranked loan structures and the interest rate for each of the additional loan structures to the dealer computer program or the individual computer program; and
the lender computer program receives acceptance of the initial loan structure or one of the additional loan structures from the dealer computer program or the individual computer program.

10. The system of claim 9, wherein the plurality of loan parameters comprise a loan term, a loan amount, and a down payment amount.

11. The system of claim 9, wherein the third party data source comprises a credit bureau.

12. The system of claim 10, wherein the different loan parameters in each of the additional loan structures differ by at least one of the loan term, the loan amount, and the down payment amount.

13. The system of claim 9, wherein the additional loan structures are ranked based on predicted acceptance rates for each of the plurality of addition loan structure.

14. The system of claim 13, wherein the predicted acceptance rates are generated by a machine learning engine that is trained using acceptances from individual having a similar income, credit score, geographical area, and/or vehicle being purchased.

15. The system of claim 9, wherein approval for the initial loan structure and the approval for the additional loan structures comprise embedded annotations.

16. The system of claim 15, wherein the annotations identify a unique feature of the initial loan structure or the additional loan structure.

17. A non-transitory computer readable storage medium, including instructions stored thereon, which when read and executed by one or more computer processors, cause the one or more computer processors to perform steps comprising:
receiving an application for a loan having an initial loan structure comprising a plurality of loan parameters from a dealer or an individual;
retrieving data for the individual from a credit bureau;
caching the data in a local cache;
decisioning the initial loan structure using the plurality of parameters and the cached data;
returning an approval for the initial loan structure and an interest rate for the initial loan structure to the dealer or the individual;
generating a plurality of additional loan structures, each additional loan structure having a plurality of different parameters, wherein the different loan parameters in each of the additional loan structures differ by at least one of a loan term, a loan amount, and a down payment amount;
decisioning each of the plurality of additional loan structures using the different parameters for each additional loan structure and the cached data;
ranking the additional loan structures with the interest rate for each additional loan structure, wherein the additional loan structures are ranked based on predicted acceptance rates for each of the plurality of addition loan structure;
returning approval for each of the ranked loan structures and the interest rate for each of the additional loan structures to the dealer or the individual; and
receiving acceptance of the initial loan structure or one of the additional loan structures.

18. The non-transitory computer readable storage medium of claim 17, wherein the plurality of loan parameters comprise a loan term, a loan amount, and a down payment amount.

19. The non-transitory computer readable storage medium of claim 17, wherein the predicted acceptance rates are generated by a machine learning engine that is trained using acceptances from individual having a similar income, credit score, geographical area, and/or vehicle being purchased.

20. The non-transitory computer readable storage medium of claim 17, wherein approval for the initial loan structure and the approval for the additional loan structures comprise embedded annotations, and the annotations identify a unique feature of the initial loan structure or the additional loan structure.
